(19) United States
(12) Patent Application Publication
(10) Pub. No.: US 2023/0167654 A1
(43) Pub. Date: Jun. 1, 2023

(54) DEMOUNTABLE TANK

(71) Applicant: CONCEPT SERVICES IP PTY LTD, Bowen Hills (AU)

(72) Inventors: Kieron Michael JEFFRIES, Bowen Hills (AU); Shaun Edward BARRY, Bowen Hills (AU)

(21) Appl. No.: 18/153,854

(22) Filed: Jan. 12, 2023

Related U.S. Application Data
(63) Continuation of application No. PCT/AU21/50384, filed on Apr. 28, 2021.

(51) Int. Cl. E04H 7/18

(52) U.S. Cl. CPC E04H 7/18

(57) ABSTRACT

A demountable tank, and method of constructing same, having a plurality of precast wall panels retained by a cable tensioning system to form a continuous, preferably circular, wall. The tank can be easily assembled at a site with prefabricated parts and easily deconstructed when no longer needed. The shape of the precast wall panels in conjunction with the cable tensioning system means no additional frame or supports are required.

### FIELD OF THE INVENTION

The invention relates to a demountable tank. In particular, the invention relates, but is not limited, to a modular, demountable liquid storage tank formed from on a site by a plurality of demountable panels.

### BACKGROUND TO THE INVENTION

Reference to background art herein is not to be construed as an admission that such art constitutes common general knowledge.

Tanks of various shapes and sizes are known for storing fluids, in particular liquids, such as water. Such tanks vary in size tremendously from, for example, a personal water storage tank for drinking or irrigation purposes to industrial or commercial storage tanks. Small tanks are relatively easy to assemble and can often be moulded as a single piece (e.g. 1-5 KL water storage tanks). However, as tank sizes increase it becomes increasingly more difficult to construct a sealed tank for storing fluid.

One of the issues with constructing large tanks is in transporting and building the tank, particularly for remote locations. For example, in mining, oil, and gas applications, water is a common by-product which may be processed and/or stored in tanks, or reservoirs, or the like. The storage of these liquids in the tanks may be long term or temporary. In any event, often the well or mine site is in a remote location with limited infrastructure and building a tank requires significant preparation and logistics.

Large tanks often suffer from hoop stress and, when empty, wind loading. Furthermore, the walls of the tank may need to be reinforced with an external structure. For example, the walls of the tank may be reinforced with a frame. Such a frame typically has support members which extend radially outwards from the tank walls. In one tank design, the support members are steel ‘A’-frame members. Disadvantageously, such supporting framework requires additional space around the tank walls. As the support members need to be provided with suitable support, the concrete pad or footing also needs to be large enough to extend to at least the outer edge of the framework, further increasing costs and environmental impact of the tank.

### OBJECT OF THE INVENTION

It is an aim of this invention to provide a demountable tank which overcomes or ameliorates one or more of the disadvantages or problems described above, or which at least provides a useful alternative.

Other preferred objects of the present invention will become apparent from the following description.

### SUMMARY OF INVENTION

In one form, although it need not be the only or indeed the broadest form, there is provided a demountable tank comprising:

a plurality of precast wall panels arrangeable to form a continuous wall; and

a tensioning system comprising one or more cables configured to extend around the continuous wall;

wherein the wall panels and cable tensioning system are configured to retain abutting wall panels in an interference fit.

The wall panels may be made of a cementitious material. The wall panels may comprise precast concrete panels. The wall panels may be substantially planar. The wall panels may be rectangular. The wall panels may have side walls at a transverse angle to the plane of the panel. The side walls may be angled from 0° to 5° relative to the orthogonal axis of the plane of the panel. The angled side walls may be angled in opposite directions, preferably forming an isosceles trapezoid in a cross-section of the wall panel.

The wall panels may have at least one channel that receives the tensioning system. The channel may be in the form of a conduit through the panel. Each wall panel may comprise a plurality of channels. The channels may be spaced apart.

The continuous wall is preferably circular or, at least, substantially circular. One or more single cables may extend around the continuous wall. Alternatively, a plurality of cables may collectively extend around the continuous wall. The cable may be external to the wall panels, may be internal to the wall panels, or partially external and partially internal to the wall panels.

At least one of the wall panels may comprise a cable retainer. The cable tensioning system may comprise a cable anchor at least one end of the cable. The cable tensioning system may comprise a cable anchor at each end of the cable. The cable retainer of the wall panel may be configured to receive and retain the cable anchor. The tensioning system may comprise a single cable tensioning system extending the perimeter of the continuous wall. The cable tensioning system may comprise a plurality of cables each extending around a portion of the perimeter of the continuous wall. The continuous wall preferably has no support structures, such as buttresses, extending radially or perpendicularly to the wall panels.

The demountable tank may comprise a liner configured to fluidly seal the wall panels and a floor of the demountable tank. The liner preferably lines an inner surface of the tank defined by the inner surface of the wall and the floor. The floor preferably includes a surface upon which the wall panels are placed. The surface may be earthen, preferably graded. The liner preferably comprises a leak detection system. The leak detection system preferably comprises a leak detection layer fluidly connected to an outlet. The outlet is preferably a sump. A communications device may be provided to transmit a signal if a leak is detected. A pump may be configured to return fluid in the sump back into the demountable tank.

In a preferred embodiment there are between 15 and 500 wall panels, more preferably between 20 and 400 wall panels, and even more preferably between approximately 25 and 300 wall panels.

In another form, there is provided a method of assembling a tank on a site, the method comprising the steps of:

erecting a plurality of precast wall panels at the site to form a continuous wall;

surrounding the continuous wall with one or more cables;

tightening the one or more cables to retain the plurality of wall panels in an interference fit.

The method may comprise levelling a ground surface to form the floor. The floor may be earthen. The method may comprise creating a pad for form the floor. The method may comprise creating a concrete pad.

The method may comprise supporting the plurality of precast wall panels with temporary supports until the tensioning system is tightened to hold the wall panels in the interference fit. The method may comprise anchoring one or more cables one or more recesses of at least one wall panel. The method may further comprise passing one or more cables through channels in the wall panels.

The method may comprise applying a liner to fluidly seal the wall panels and floor.

The method of constructing a demountable tank preferably comprises constructing the demountable tank as hereinbefore described.

Further features and advantages of the present invention will become apparent from the following detailed description.

### BRIEF DESCRIPTION OF THE DRAWINGS

By way of example only, preferred embodiments of the invention will be described more fully hereinafter with reference to the accompanying figures, wherein:

FIG. 1 illustrates a perspective view of a demountable tank;

FIG. 2 a cross sectional view of adjacent wall panels of the demountable tank; and

FIG. 3 illustrates a diagrammatic cross-sectional view of a leak detection system.

### DETAILED DESCRIPTION OF THE DRAWINGS

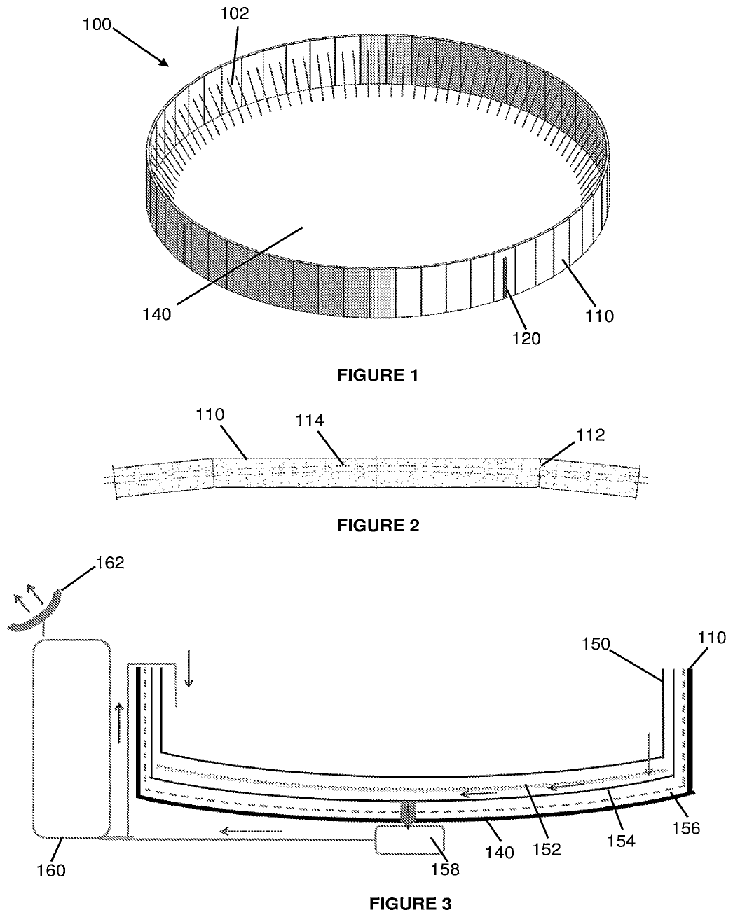

FIG. 1 illustrates a demountable tank 10. Optional temporary supports 102, which may be used during construction, are also shown. A plurality of precast wall panels 110 are arranged adjacent one another to form a substantially circular continuous wall 100. The panels 110 are planar such that each forms a circle segment. In the illustrated wall 100 there are approximately 200 wall panels 110. Once the wall 100 has been erected and retained by a tensioning system the temporary supports 102 can be removed and the wall 100 is self standing.

As shown in FIG. 2, the wall panels 110 have side walls 112 that are at a transverse angle, preferably between 0° and 5° to an orthogonal axis of the plane of the panels 110. In cross-section the wall panels have an isosceles trapezoid shape. The wall panels 110 also have a channel 114 configured to receive a cable from a cable tensioning system. The tensioning cable is passed through the channels 114 of adjacent wall panels 110 and tensioned at cable anchors 120 in selected wall panels 110. A plurality of tensioning cables, anchored by a plurality of cable anchors 120, may be provided to extend around the continuous wall.

The angled side walls 112 allow the wall panels 110 to abut each other and provide support in a ‘keystone’ manner such that they cannot fall inward. The cable tensioning system retains the wall panels 110 in such an arrangement and provides support such that the wall panels cannot fall outward. In use, radial forces from liquid 20 contained therein provides a radial force against the wall panels 110. The tensioning system must therefore be of sufficient strength to not just hold the wall panels 110 in place in a freestanding manner, but also to be able to withstand the radial forces caused by the liquid 20 contained therein.

To construct the demountable tank 10, a suitable site is first determined. The site may be prepared first, such as by levelling a ground surface and/or creating a pad to form a floor of the tank 10. Once a suitable ground surface has been determined, a plurality of precast wall panels 110 can be erected to form a continuous wall 100. Temporary supports 102 may be utilised to support the wall panels 110 during construction. A tensioning system is then applied to the wall panels 110 and tightened to hold the wall panels 110 in an interference fit.

FIG. 3 illustrates a liner and leak detection system comprising a first liner 150, a geonet layer 152, a leak detection liner 154, and a cushioning layer which may be in the form of a geotextile 156. An internal sump 158 is fluidly connected to the leak detection liner 154 which is in turn fluidly connected to an external sump 160 having a communication system 162 to transmit a signal indicating detection of a leak. The sumps 158, 160 may also have a pump (not shown) to return leaked fluid back into tank 100. In the event of a leak in the first liner 150, fluid enters a geonet cavity formed by the geonet layer 152 and is caught by the leak detection layer whereby it can flow into the sump and back into the tank 100 as illustrated by the arrows. Water from the internal sump is preferably gravity fed to the external sump which can activate a pump, preferably a solar pump, to return water to the tank 100.

Advantageously, the demountable tank 10 can be constructed quickly and relatively cost effectively at a site in a modular and adaptable manner. It can be a temporary or permanent installation with casting performed off-site. Waste liquids, such as effluent or industrial wastes, can then be stored in the demountable tank 10. The shape of the precast wall panels in conjunction with the cable tensioning system means no additional frame or supports are required, reducing parts and footprint.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

As used herein, an element or operation recited in the singular and proceeded with the word “a” or “an” should be understood as not excluding plural elements or operations, unless such exclusion is explicitly recited. Furthermore, references to “one embodiment” of the present disclosure are not intended to be interpreted as excluding the existence of additional embodiments that also incorporate the recited features.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

1. A demountable tank comprising:
a plurality of precast wall panels arrangeable to form a continuous wall; and
a tensioning system comprising one or more cables configured to extend around the continuous wall;
wherein the wall panels and cable tensioning system are configured to retain abutting wall panels in an interference fit.

2. The demountable tank of claim 1, wherein the wall panels are precast concrete panels.

3. The demountable tank of claim 1, wherein wall panels are substantially planar.

4. The demountable tank of claim 1, wherein the wall panels have side walls at a transverse angle to the plane of the panel.

5. The demountable tank of claim 4, wherein the angled side walls are angled in opposite directions to form an isosceles trapezoid in a cross-section of the wall panel.

6. The demountable tank of claim 1, wherein the wall panels comprise at least one channel that receives the one or more cables of the tensioning system.

7. The demountable tank of claim 1, wherein each wall panel comprises a plurality of spaced apart channels.

8. The demountable tank of claim 1, wherein a plurality of cables collectively extend around the continuous wall.

9. The demountable tank of claim 1, wherein at least one of the wall panels comprises a cable retainer configured to receive and retain a cable anchor at an end of the cable.

10. The demountable tank of claim 1, wherein each cable comprises a cable anchor at each end.

11. The demountable tank of claim 1, further comprising a liner configured to fluidly seal the wall panels and a floor of the demountable tank.

12. The demountable tank of claim 11, wherein the liner comprises a leak detection system.

13. The demountable tank of claim 12, wherein the leak detection system comprises a leak detection layer fluidly connected to an outlet.

14. The demountable tank of claim 13, wherein the outlet is a sump with a pump configured to return fluid from the sump back into the demountable tank.

15. A method of assembling a tank on a site, the method comprising the steps of:
erecting a plurality of precast wall panels at the site to form a continuous wall;
surrounding the continuous wall with one or more cables; and
tightening the one or more cables to retain the plurality of wall panels in an interference fit.

16. The method of claim 15, further comprising the step of supporting the plurality of precast wall panels with temporary supports until the tensioning system is tightened to hold the wall panels in the interference fit.

17. The method of claim 15, further comprising the step of anchoring one or more cables in one or more recesses of at least one wall panel.

18. The method of claim 15, further comprising the step of passing one or more cables through channels in the wall panels.
